(19) United States
(12) Patent Application Publication
(10) Pub. No.: US 2020/0350594 A1
(43) Pub. Date: Nov. 5, 2020

(54) AIR ELECTRODE FOR LITHIUM AIR BATTERIES INHIBITING EXCESSIVE GROWTH OF DISCHARGE PRODUCTS AND METHOD OF MANUFACTURING THE SAME

(71) Applicants: HYUNDAI MOTOR COMPANY, Seoul (KR); Kia Motors Corporation, Seoul (KR)

(72) Inventors: Gwang Seok OH, Seoul (KR); Jee Youn HWANG, Seoul (KR)

(73) Assignees: HYUNDAI MOTOR COMPANY, Seoul (KR); Kia Motors Corporation, Seoul (KR)

(21) Appl. No.: 16/688,358

(22) Filed: Nov. 19, 2019

(30) Foreign Application Priority Data
May 2, 2019 (KR) 10-2019-0051565

(51) Int. Cl. H01M 4/90; H01M 4/96; H01M 4/88; H01M 12/06; H01M 4/86

(52) U.S. Cl. CPC H01M 4/9016; H01M 4/96; H01M 4/8652; H01M 12/06; H01M 4/8882

(57) ABSTRACT

Disclosed are an air electrode for lithium air batteries capable of increasing the lifespan of lithium air batteries and improving the output thereof by inhibiting the excessive growth of discharge products, and a method of manufacturing the same. Specifically, the air electrode for lithium air batteries includes a plurality of seeds including a nano-sized oxide particle, and a carbon web wrapping the seeds.

### CROSS-REFERENCE TO RELATED APPLICATION

This application claims, priority to and the benefit of Korean Patent Application No. 10-2019-0051565 filed on May 2, 2019, the entire contents of which are incorporated herein by reference.

### FIELD

The present disclosure relates to an air electrode for lithium air batteries capable of increasing the lifespan of lithium air batteries and improving the output thereof.

### BACKGROUND

The statements in this section merely provide background information related to the present disclosure and may not constitute prior art.

Upon discharge of a lithium air battery, oxygen, a lithium ion and an electron react at an air electrode to produce a discharge product, as depicted in the following Reaction Scheme.

2Li⁺+2e⁻↔Li₂O₂(s)

As the capacity of a lithium air battery increases, the discharge product grows unevenly in a toroidal form on the surface of the carbon material in the air electrode. In such a case, the discharge product is not efficiently decomposed when charging because of the very low lithium ion conductivity and electron conductivity of the discharge product. In addition, the electrolyte and surrounding materials may be decomposed due to the application of large overvoltage in order to decompose the discharge product. As a result, the lifespan of the battery is greatly reduced. As such, the size and shape of the discharge product greatly affect the capacity, output and lifespan of lithium air batteries.

Conventionally, metal and/or metal oxide catalysts have been applied to efficiently decompose discharge products. However, the use of such catalysts causes decomposition of the electrolyte as well as the discharge products and thus has a disadvantage of a great reduction in lifespan.

Also, the structure of carbon materials has been improved in order to induce decomposition and generation of discharge products. However, improving the structure of carbon materials in this way makes it difficult to control the excessive growth of discharge products and faces a limitation in that it is easy to apply overvoltage.

The above information disclosed in this Background section is provided only for enhancement of understanding of the background of the invention and therefore it may contain information that does not form the prior art that is already known in this country to a person of ordinary skill in the art.

### SUMMARY

The present disclosure provides an air electrode for lithium air batteries capable of increasing the lifespan of lithium air batteries and improving the output thereof by inhibiting the excessive growth of discharge products, and a method of manufacturing the same.

The objects of the present invention are not limited to those described above. The objects of the present invention will be clearly understood from the following description and can be implemented by the means defined in the claims and combinations thereof.

In one aspect, the present invention provides an air electrode for lithium air batteries including a plurality of seeds including a nano-sized oxide particle and a carbon web wrapping the seeds.

The air electrode may include a plurality of units formed by wrapping and fixing the seeds by the carbon web.

The seeds may include the same one as discharge products.

The seeds may include Li₂O₂.

The carbon web may include at least one selected from the group consisting of graphene, graphene oxide, reduced graphene oxide and a combination thereof.

The carbon web may include a wrinkled portion.

The discharge products may be produced near the seeds wrapped by the carbon web upon discharge.

In another aspect, the present invention provides a method of manufacturing an air electrode for lithium air batteries including preparing a dispersion of a starting material including seeds including a nano-sized oxide particle and a carbon web, and reducing the carbon web while controlling a pH of the dispersion.

The reduction of the carbon web may be carried out by adjusting the pH of the dispersion to a range of more than 2 and less than 10.

A wrinkled portion may be formed in the carbon web by reducing the carbon web.

The seeds may be wrapped and fixed by the carbon web to form a unit by reducing the carbon web.

The method may further include filtering the dispersion to obtain an electrode material and heat-treating the electrode material.

Other aspects and preferred embodiments of the invention are discussed infra.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

The above and other features of the present invention will now be described in detail with reference to certain exemplary embodiments thereof, illustrated in the accompanying drawings, which are given herein below by way of illustration only, and thus are not limitative of the present invention, and wherein:

FIG. 1 is a cross-sectional view schematically showing a lithium air battery according to the present invention;

FIG. 2 is a schematic view showing a unit contained in an air electrode according to the present invention;

FIG. 3 is a schematic view showing an air electrode according to the present invention;

FIG. 4 is a flowchart illustrating a method of manufacturing the air electrode according to the present invention;

FIGS. 5A and 5B show the results of scanning electron microscope (SEM) analysis regarding a carbon web according to Example, and specifically, FIG. 5A shows the result at a magnification of 3,000× and FIG. 5B shows the result at a magnification of 10,000×;

FIGS. 6A and 6B show the results of scanning electron microscope (SEM) analysis regarding a carbon web according to Comparative Example 1, and specifically, FIG. 6A shows the result at a magnification of 10,000× and FIG. 6B shows the result at a magnification of 20,000×;

FIGS. 7A and 7B show the results of SEM analysis regarding the air electrode according to Comparative Example 3, and specifically, FIG. 7A shows the result at a magnification of 3,000× and FIG. 7B shows the result at a magnification of 20,000×;

FIGS. 8A and 8B show the results of scanning electron microscope (SEM) analysis of an air electrode after discharging (5 mAh/cm² cut-off) of the lithium air batteries according to Example, and specifically, FIG. 8A shows the result at a magnification of 10,000× and FIG. 8B shows the result at a magnification of 20,000×; and

FIGS. 9A and 9B show the results of scanning electron microscope (SEM) analysis of an air electrode after discharging (5 mAh/cm² cut-off) of the lithium air battery according to Comparative Example 3, and specifically, FIG. 9A shows the result at a magnification of 10,000× and FIG. 9B shows the result at a magnification of 20,000×.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The objects described above, and other objects, features and advantages of the present invention, will be clearly understood from the following preferred embodiments with reference to the attached drawings. However, the present invention is not limited to the embodiments and may be embodied in different forms. The embodiments are suggested only to offer a thorough and complete understanding of the disclosed context and to sufficiently inform those skilled in the art of the technical concept of the present invention.

Like numbers refer to like elements throughout the description of the figures. In the drawings, the sizes of structures are exaggerated for clarity. It will be understood that, although the terms “first”, “second”, etc. may be used herein to describe various elements, these elements should not be construed to be limited by these terms, which are used only to distinguish one element from another. For example, within the scope defined by the present invention, a “first” element may be referred to as a “second” element, and similarly, the “second” element may be referred to as the “first” element. Singular forms are intended to include plural forms as well, unless the context clearly indicates otherwise.

It will be further understood that the terms “comprises” and/or “has”, when used in this specification, specify the presence of stated features, integers, steps, operations, elements, components or combinations thereof, but do not preclude the presence or addition of one or more other features, integers, steps, operations, elements, components, or combinations thereof. In addition, it will be understood that when an element such as a layer, film, region or substrate is referred to as being “on” another element, it can be directly on the other element, or an intervening element may also be present. It will also be understood that when an element such as a layer, film, region or substrate is referred to as being “under” another element, it can be directly under the other element, or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numerical ranges are disclosed in the description, these ranges are continuous and include all numbers from the minimum to the maximum including the maximum within each range unless otherwise defined. Furthermore, when the range refers to an integer, it includes all integers from the minimum to the maximum including the maximum within the range, unless otherwise defined.

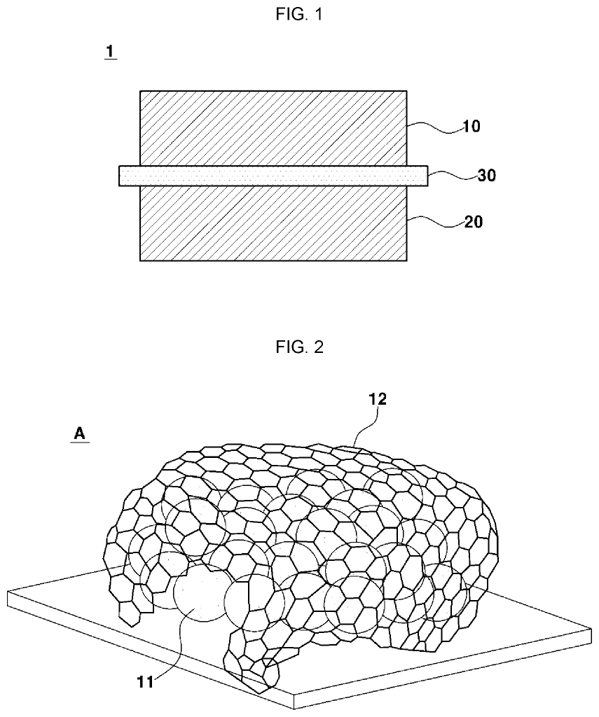

FIG. 1 is a cross-sectional view schematically showing a lithium air battery according to the present invention. The lithium air battery 1 includes an air electrode 10, a cathode 20, a separator 30 interposed between the air electrode 10 and the cathode 20, and an electrolyte (not shown) impregnated into the air electrode 10, the cathode 20 and the separator 30.

The lithium air battery 1 is a battery system that uses a lithium metal for the cathode 20 and uses oxygen in the air as an active material in the air electrode 10.

Oxidation and reduction of lithium occur in the cathode 20, and reduction and oxidation of oxygen introduced from the outside occur in the air electrode 10.

The separator 30 is an element that physically isolates the air electrode 10 and the cathode 20 from each other to prevent a short circuit.

The electrolyte (not shown) is an element that transfers lithium ions between the air electrode 10 and the cathode 20. The electrolyte (not shown) may include a lithium salt. The lithium salt is dissolved in a solvent and can act as a source of lithium ions in the battery. Any lithium salt may be used without particular limitation, as long as it is one that is ordinarily used, and the lithium salt may for example include at least one selected from the group consisting of LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiF, LiBr, LiCl, LiI, LiB(C₂O₄)₂, LiCF₃SO₃, LiN(SO₂CF₃)₂(LiTFSI), LiN(SO₂C₂F₅)₂ and LiC(SO₂CF₃)₃.

The following Reaction Schemes 1 and 2 show the reactions occurring in the cathode 20 and the air electrode 10 upon discharge of the lithium air battery 1.

(Cathode):Li→Li⁺+e⁻ [Reaction Scheme 1]

(Air electrode):2Li⁺+O₂+2e⁻→Li₂O₂ [Reaction Scheme 2]

The lithium metal of the cathode 20 is oxidized to produce a lithium ion and an electron. The lithium ion moves to the air electrode 10 through the electrolyte (not shown), and the electrons move to the air electrode 10 through the current collector and the external conducting wire (lead). Since the air electrode 10 is porous, it allows for the introduction of external air. The oxygen contained in the outside air is reduced by the electron in the air electrode 10, and Li₂O₂ is produced as a discharge product.

The charge reaction proceeds in an opposite way. Li₂O₂ is decomposed in the air electrode 10 to produce a lithium ion and an electron, as depicted in the following Reaction Scheme 3.

(Air electrode)Li₂O₂→2Li⁺+O₂+2e⁻ [Reaction Scheme 3]

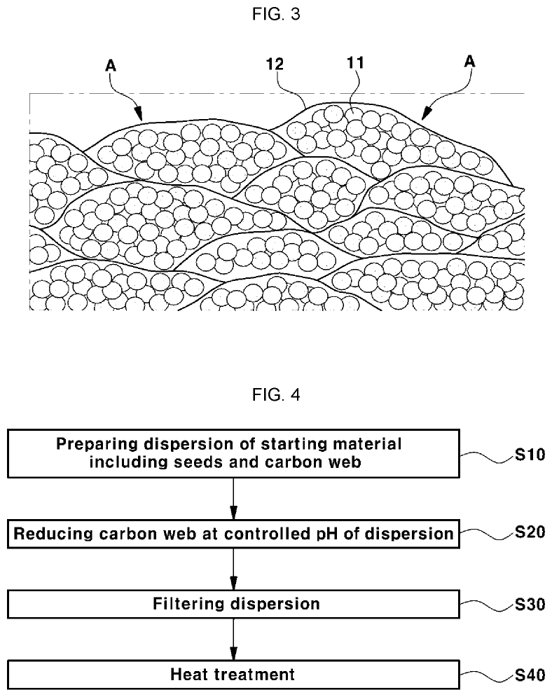

The air electrode 10 according to the present invention will be described in detail with reference to FIGS. 2 and 3. Referring to these drawings, the air electrode 10 may be formed by aggregating a plurality of units A, each including a plurality of seeds 11 and a carbon web 12 wrapping the same.

Upon discharge of the lithium air battery, lithium ions, electrons and oxygen react with one another in the presence of the seed 11 in the carbon web 12 and thus discharge products start to grow. Since the seed 11 functions as a kind of nucleus for the discharge product, the discharge product is difficult to grow in the absence of the seed 11. Therefore, the discharge product grows in the carbon web 12 in a region where the seed 11 exists.

The seeds 11 are evenly distributed in the air electrode 10 and the carbon web 12 physically prevents the size of the discharge product from increasing, thus avoiding the formation of a large agglomerate of discharge products. Therefore, the electron conduction path in the air electrode 10 for decomposition of the discharge product is shortened, so that an oxygen evolution reaction (OER) is possible even at a low voltage and thus overvoltage does not occur. As a result, the lifespan of the lithium ion battery is increased and the capacity is improved.

The seed 11 is a nano-sized lithium oxide and includes the same one as the discharge product. Specifically, the seed 11 may include Li₂O₂. Therefore, the seed 11 can function as a kind of nucleus when the discharge product grows.

The size of the seed 11 is not particularly limited, but the seed 11 preferably has an average particle diameter of 10 nm to 500 nm.

The carbon web 12 may wrap (surround) a plurality of seeds 11. The seed 11 may be trapped and fixed in the inner space of the carbon web 12.

The carbon web 12 may include one selected from the group consisting of graphene, graphene oxide, reduced graphene oxide and a combination thereof. Preferably, the carbon web 12 may include graphene oxide having an oxygen functional group and/or reduced graphene oxide, to which the seed 11 can bind.

More preferably, the carbon web 12 may include reduced graphene oxide. The reduced graphene oxide may be obtained by reducing sheet-shaped graphene oxide at a suitable pH. As the graphene oxide is reduced under the conditions described above, it is converted into reduced graphene oxide which is crumpled and wrinkled. Accordingly, the carbon web 12 may include wrinkles. Since the carbon web 12 has a crumpled and wrinkled shape, rather than a sheet shape, it can wrap and fix the seed 11, as shown in FIG. 2.

The weight ratio of the carbon web 12 to the seed 11 is not particularly limited, but may be in a weight ratio of 80:20 to 99:1.

FIG. 4 is a flowchart illustrating a method of manufacturing the air electrode 10 according to the present invention. Referring to FIG. 4, the method of manufacturing the air electrode 10 includes preparing a dispersion of a starting material including the seed 11 and the carbon web 12 (S10), reducing the carbon web 12 while controlling a pH of the dispersion (S20), filtering the dispersion to obtain an electrode material (S30), and heat-treating the electrode material (S40).

The method of manufacturing the air electrode 10 may further include molding the resulting product obtained through the heat treatment into a layer having a predetermined shape through a dry or wet process.

The step of preparing the dispersion of starting material (S10) may be a step of dispersing the seeds 11 and the carbon web 12 into a solvent.

The solvent is not particularly limited, but is preferably an aqueous solvent. Specifically, the solvent may be water (H₂O).

The weight ratio of the carbon web 12 and the seed 11 constituting the starting material is not particularly limited, but is preferably 80:20 to 99:1.

The manufacturing method may further include subjecting the dispersion of the starting material to ultrasonication. The ultrasonication of the dispersion of the starting material enables the seeds 11 to be bound to the oxygen functional groups of the carbon web 12 and the seeds 11 to be dispersed evenly therein.

The step of reducing the carbon web 12 (S20) may include adding a reducing agent to the dispersion of the starting material, followed by stirring.

The reducing agent is not particularly limited and may be any reducing agent that is well-known in the prior art to which the present invention pertains. For example, aqueous ammonia (NH₃H₂O) may be used.

The pH of the dispersion can be controlled by varying the amount of the reducing agent. Specifically, the carbon web 12 may be reduced by adjusting the pH of the dispersion to a range of more than 2 and less than 10. As described above, the carbon web 12 includes a crumpled wrinkle portion, which can be crumpled to an appropriate level when reducing the carbon web 12 within the pH range of more than 2 and less than 10, preferably a pH of 4 to 6.

The method for stirring is not particularly limited, and stirring may be carried out by a method well known in the prior art to which the present invention pertains.

In addition, the conditions for stirring are not particularly limited. Preferably, the stirring may be carried out at 50° C. to 90° C. for 10 hours to 48 hours.

As a result, a reducing agent is applied to the dispersion of the starting material and the dispersion is stirred to reduce the carbon web 12, so that a plurality of the seeds 11 is wrapped by the carbon web 12 to form a fixed unit A.

Then, the dispersion may be filtered to obtain an electrode material, and the electrode material may be heat-treated.

The filtration method is not particularly limited and may be carried out by any method that is well-known in the prior art to which the present invention pertains. For example, a method of vacuum filtration can be used.

The heat treatment conditions are not particularly limited, but heat treatment is preferably carried out under an inert gas atmosphere such as nitrogen (N₂) or argon (Ar) gas at 400° C. to 800° C. for 10 minutes to 2 hours.

By forming the air electrode 10 according to the manufacturing method described above, it is possible to inhibit the overgrowth of the discharge product in the air electrode 10 upon discharge of the lithium air battery 1. Specifically, when the discharge product grows with the seed 11 as a nucleus, the carbon web 12 suppresses the undesirable overgrowth of the discharge product. Therefore, overvoltage does not occur, and the lifespan and output of the lithium ion battery 1 are improved.

Hereinafter, the present invention will be described in more detail with reference to examples. However, the following examples should not be construed as limiting the scope of the present invention.

### EXAMPLE

(S10) Graphene oxide and Li₂O₂ were mixed at a weight ratio of 90:10 and then dispersed in water to prepare a dispersion. The dispersion was ultrasonicated for about 30 minutes.

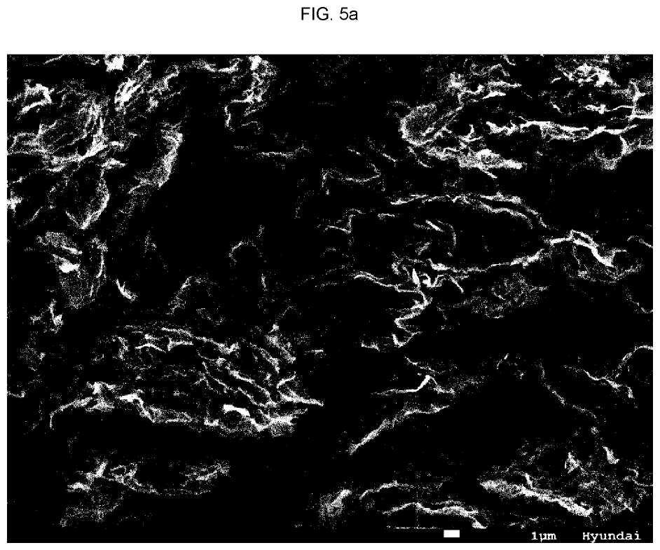

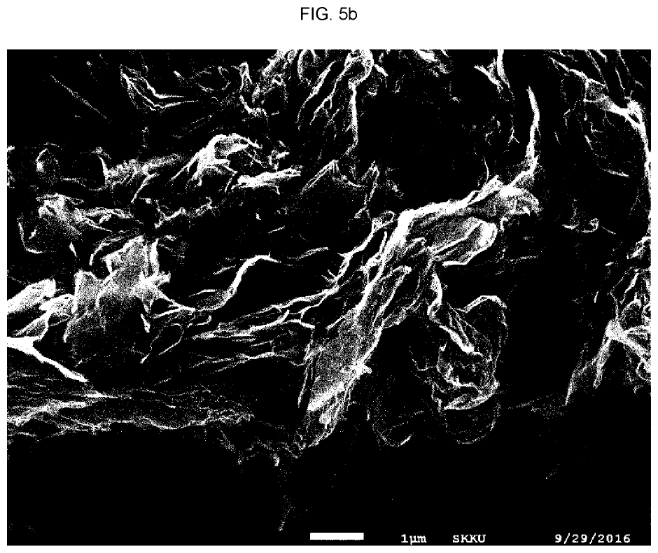

(S20) Ammonia water as a reducing agent was added to the dispersion to adjust the pH of the dispersion to 5 and the graphene oxide was reduced by stirring at about 80° C. for about 24 hours. Through this, the reduced graphene oxide, which is a carbon web, wrapped the seed, Li₂O₂ to form a unit. FIGS. 5A and 5B show the results of scanning electron microscope (SEM) analysis regarding a carbon web reduced at pH 5. As can be seen from FIGS. 5A and 5B, the carbon web was crumpled and wrinkled.

(S30) The dispersion was filtered under reduced pressure to obtain an electrode material.

(S40) The electrode material was heat-treated in an oven filled with nitrogen gas at about 600° C. for about 30 minutes.

The heat-treated electrode material and polytetrafluoroethylene (PTFE) as a binder were mixed at a weight ratio of 9:1 and then dry-mixed using a ball mill (planetary mill, FRITSCH) at about 100 rpm for 1 hour. The resulting product was rolled to obtain an air electrode having a thickness of about 100 μm and a loading amount of about 2 mg/cm².

A lithium metal foil having a thickness of about 500 μm was used as a cathode. Polyethylene having a thickness of about 25 μm was used as a separator. The air electrode, the separator and the cathode were sequentially laminated, and 1M LiNO₃ in DMAc (dimethylacetamide), as an electrolyte, was injected to complete the lithium air battery.

### Comparative Example 1

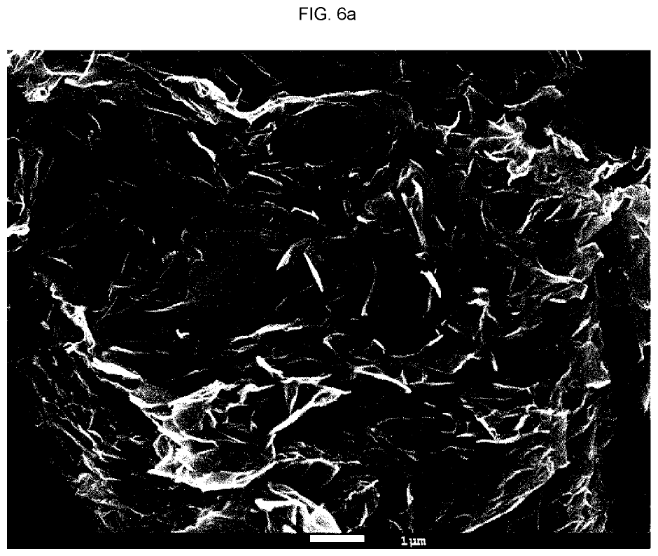

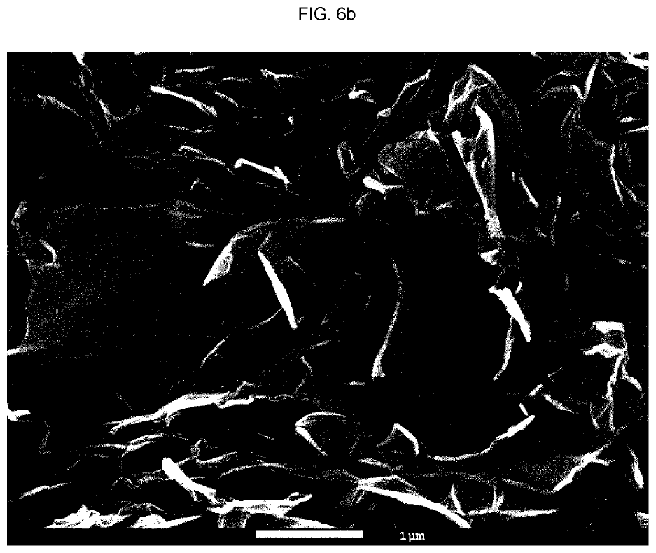

A lithium air battery was completed in the same manner as in Example 1, except that the pH of the dispersion was adjusted to 10 in the step of reducing the carbon web (S20). FIGS. 6A and 6B show the results of scanning electron microscope (SEM) analysis regarding a carbon web reduced at pH 10. As can be seen from FIGS. 6A and 6B, the carbon web reduced at pH 10 was in the form of a non-crumpled sheet. Therefore, the carbon web was not able to wrap the seed and made it difficult to form the unit A as in the present invention.

### Comparative Example 2

A lithium air battery was completed in the same manner as in Example 1, except that the pH of the dispersion was adjusted to 2 in the step of reducing the carbon web (S20).

### Comparative Example 3

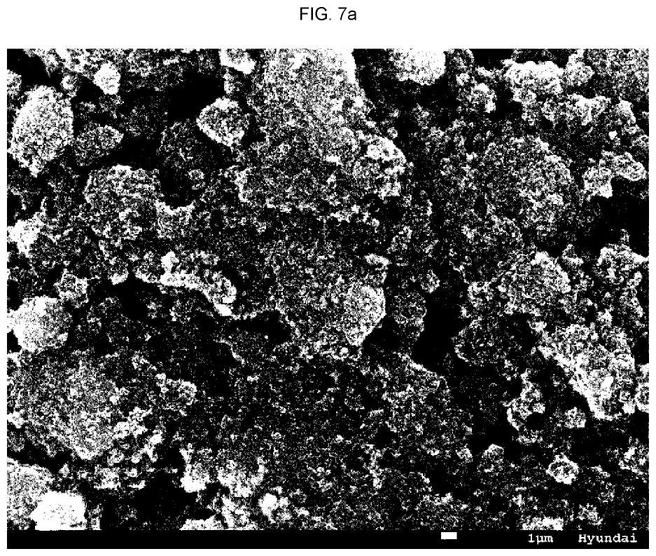

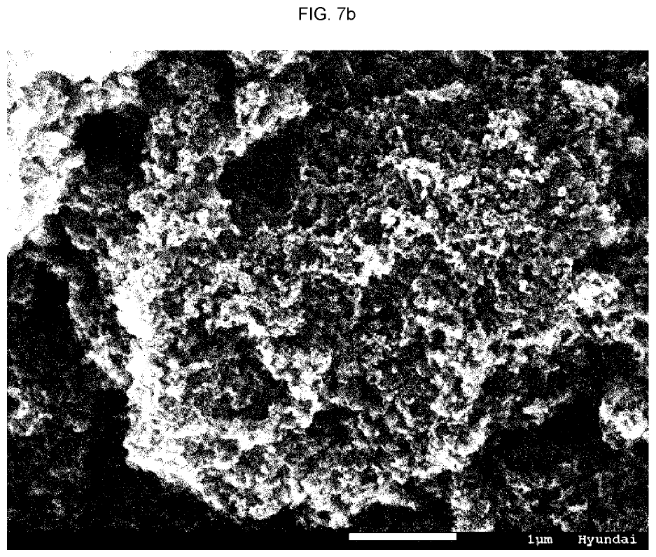

Carbon black (Ketjen black 600) and polytetrafluoroethylene (PTFE) as a binder were mixed at a weight ratio of 9:1 and then dried using a ball mill (planetary mill, FRITSCH) at about 100 rpm for 1 hour. The resulting product was rolled to obtain an air electrode having a thickness of about 100 μm and a loading amount of about 2 mg/cm². FIGS. 7A and 7B show the results of SEM analysis regarding the air electrode according to Comparative Example 3. As can be seen from FIGS. 7A and 7B, the air electrode did not have any unit A, as in the present invention.

A lithium metal foil having a thickness of about 500 μm was used as a cathode. Polyethylene having a thickness of about 25 μm was used as a separator. The air electrode, the separator and the cathode were sequentially laminated and 1M LiNO₃ in DMAc (dimethylacetamide), as an electrolyte, was injected to complete the lithium air battery.

### Experimental Example

The lithium ion batteries according to Example and Comparative Examples 1 to 3 were charged and discharged, and the overvoltage and lifespan thereof were measured. The charging/discharging was carried out under the voltage range from 2V to 4.6V and an oxygen atmosphere of 2 bar (99.999%). The current density was 0.25 mA/cm².

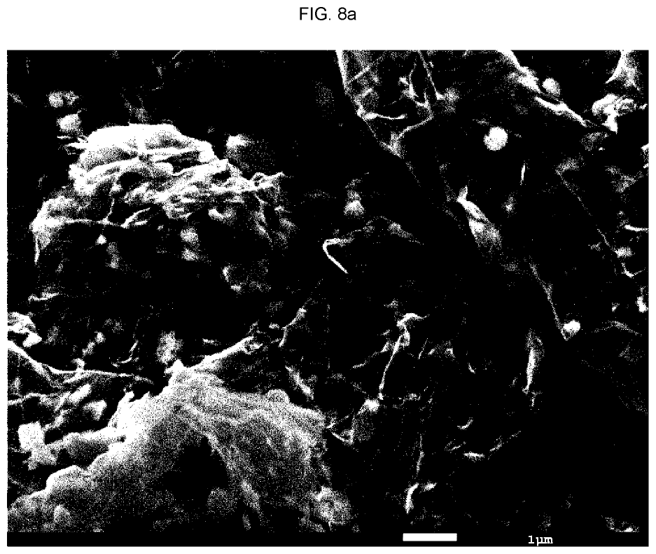

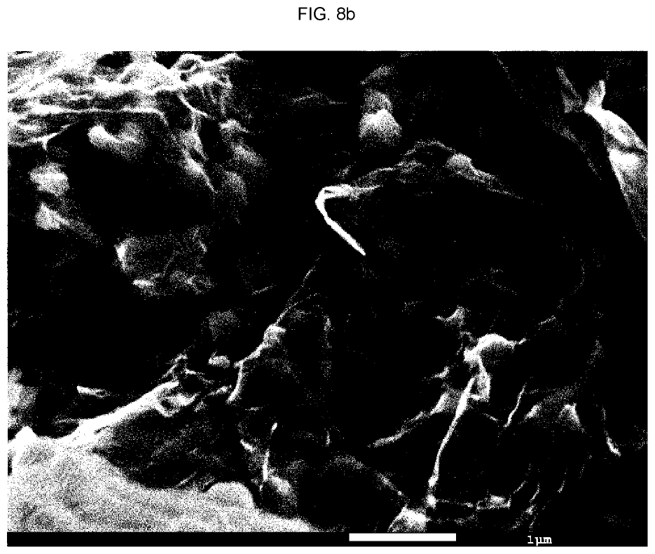

First, FIGS. 8A and 8B show the results of scanning electron microscope (SEM) analysis of an air electrode after discharge (5 mAh/cm² cut-off) of the lithium air batteries according to Example. As can be seen from FIGS. 8A and 8B, the discharge product was uniformly grown in the air electrode with the seed as a nucleus. Also, it can be seen that the overgrowth of the discharge product is inhibited by the carbon web.

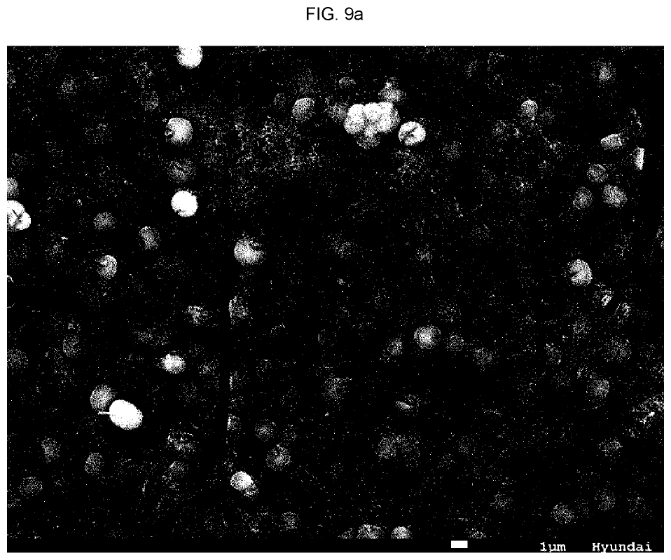

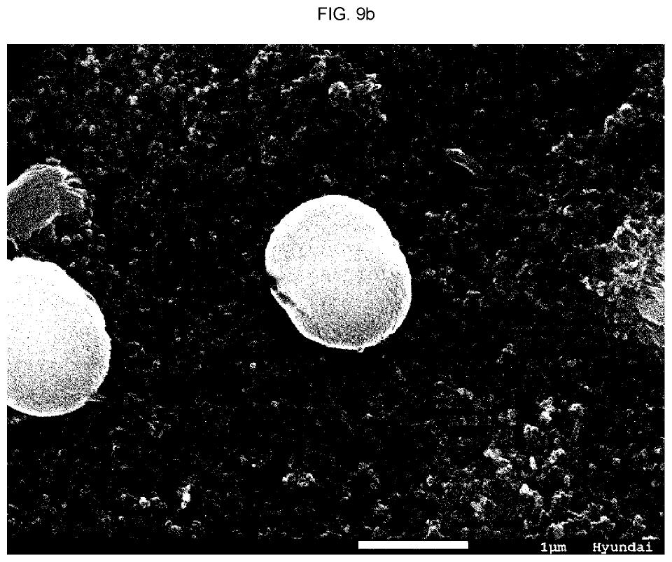

FIGS. 9A and 9B show the results of scanning electron microscope (SEM) analysis of an air electrode after discharge (5 mAh/cm² cut-off) of the lithium air battery according to Comparative Example 3. As can be seen from FIGS. 9A and 9B, the discharge product was non-uniformly distributed and was agglomerated and over-grown.

Table 1 shows the results of measurement of the overvoltage and lifespan of the lithium air batteries according to Examples and Comparative Examples 1 to 3 when they were charged and discharged.

TABLE 1

| | Shape of | | |
|---|---|---|---|
| Item | carbon web | Overvoltage[ΔV]²⁾ | Lifespan[cycle] |
| Example | Wrinkled | 0.89 | 42 |
| Comparative | Flat sheet | 1.19 | 17 |
| Example 1 | | | |
| Comparative | Excessively | 1.33 | 19 |
| Example 2 | wrinkled | | |
| Comparative | Sphere¹⁾ | 1.62 | 15 |
| Example 3 | | | |

¹⁾The shape of the carbon web of Comparative Example 3 corresponds to the shape of the carbon material contained in the air electrode.
²⁾Charge voltage-discharge voltage

Referring to Table 1, in Comparative Example 1, the carbon web had a flat sheet shape and thus was not able wrap the seed and the discharge product. Therefore, it was not possible to control the growth of the discharge product and large discharge products were formed non-uniformly on the surface of the carbon web. Also, it can be seen that the discharge products aggregated and grew excessively to an average particle diameter of about 1 μm or more, which may cause a large overvoltage and deterioration in lifespan.

In Comparative Example 2, the carbon web is highly wrinkled and stuck, thus making it difficult to produce discharge products inside the carbon web. As a result, the discharge product is grown from the outside of the carbon web, thus making it difficult to control the size thereof.

In Comparative Example 3, the discharge product is non-uniformly produced on the surface of the carbon material due to the absence of seeds. Also, it can be seen that the discharge product grows to a great extent without being limited in size, and thus the overvoltage is very large and the lifespan is deteriorated.

On the other hand, in the example described above, the seeds are uniformly dispersed and distributed, so that the discharge products grow uniformly. Also, the discharge product is grown while being trapped in the wrinkled (crumpled) carbon web, and the size thereof is thus very small, about 0.3 μm. Therefore, the discharge product is readily decomposed. As a result, the overvoltage is notably reduced and the lifespan is greatly increased.

As is apparent from the foregoing, the air electrode of the lithium air battery according to the present invention can inhibit the overgrowth of the discharge product during discharge, thereby increasing the lifetime and output of the lithium ion battery.

The effects of the present invention are not limited to those mentioned above. It should be understood that the effects of the present invention include all effects that can be inferred from the description of the present invention.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An air electrode for lithium air batteries comprising:
a plurality of seeds comprising a nano-sized oxide particle; and
a carbon web wrapping the seeds.

2. The air electrode according to claim 1, wherein the air electrode comprises a plurality of units formed by wrapping and fixing the seeds by the carbon web.

3. The air electrode according to claim 1, wherein the seeds comprise the same one as discharge products.

4. The air electrode according to claim 1, wherein the seeds comprise Li₂O₂.

5. The air electrode according to claim 1, wherein the carbon web comprises at least one selected from the group consisting of graphene, graphene oxide, reduced graphene oxide and a combination thereof.

6. The air electrode according to claim 1, wherein the carbon web comprises a wrinkled portion.

7. The air electrode according to claim 1, wherein the discharge products are produced near the seeds wrapped by the carbon web upon discharge.

8. A method of manufacturing an air electrode for lithium air batteries comprising:
preparing a dispersion of a starting material including seeds comprising a nano-sized oxide particle and a carbon web; and
reducing the carbon web while controlling a pH of the dispersion.

9. The method according to claim 8, wherein the seeds comprise the same one as discharge products.

10. The method according to claim 8, wherein the seeds comprise Li₂O₂.

11. The method according to claim 8, wherein the reduction of the carbon web is carried out by adjusting the pH of the dispersion to a range of more than 2 and less than 10.

12. The method according to claim 8, wherein a wrinkled portion is formed in the carbon web by reducing the carbon web.

13. The method according to claim 8, wherein the seeds are wrapped and fixed by the carbon web to form a unit by reducing the carbon web.

14. The method according to claim 8, wherein the carbon web comprises at least one selected from the group consisting of graphene, graphene oxide, reduced graphene oxide and a combination thereof.

15. The method according to claim 8, further comprising:
filtering the dispersion to obtain an electrode material; and
heat-treating the electrode material.
